(19) United States
(12) Patent Application Publication
(10) Pub. No.: US 2018/0040247 A1
(43) Pub. Date: Feb. 8, 2018

(54) PORTABLE PROXIMITY AND RELATIVE PROBABILITY OF INTERSECTION INDICATOR FOR INCREASED SAFETY IN LOWER VISIBILITY CONDITIONS

(71) Applicants: Benjamin C. Kuehl, Dane, WI (US); George R. Breiwa, Dane, WI (US)

(72) Inventors: Benjamin C. Kuehl, Dane, WI (US); George R. Breiwa, Dane, WI (US)

(21) Appl. No.: 15/552,018

(22) PCT Filed: Feb. 18, 2016
(86) PCT No.: PCT/US16/18513

§ 371 Date: Aug. 18, 2017

Related U.S. Application Data
(60) Provisional application No. 62/117,767, filed on Feb. 18, 2015.

(51) Int. Cl. G08G 1/16; G08G 1/0967

(52) U.S. Cl. CPC G08G 1/162; G08G 1/096791

(57) ABSTRACT

A real-time proximity and rate of closure indicator is provided including an enclosure(s) to contain the required electronic componentry for transmission, reception and processing of RF signals for the determination, interpolation and comparison of positional information including rate of closure of all devices within a given signal reception range.

### CROSS-REFERENCE TO RELATED APPLICATIONS

This application claims priority to U.S. Provisional patent application Ser. No. 62/117,767, filed Feb. 18, 2015, entitled “PORTABLE PROXIMITY AND RELATIVE PROBABILITY OF INTERSECTION INDICATOR FOR INCREASED SAFETY IN LOWER VISIBILITY CONDITIONS,” the entire contents of which is hereby incorporated by reference in its entirety.

### FIELD

The present inventions relate generally to a proximity indicator, and more specifically to a proximity detector with an approach rate analyzer with indicator(s).

### BACKGROUND

As is known, devices for communication and detection of proximity exist. These devices typically involve the broadcast of, and/or detection of a widely available signal identifying the presence of, for example, a hazard in the area. For example, a vehicle may broadcast an RF signal to a general area surrounding the vehicle to alert others in the general area of its presence. However, these devices do not convey actual real time proximity, e.g., a particular location or distance relative to others, or a rate of approach to the receiving devices. As a result, the signal serves as a warning of the presence of the vehicle, but does not communicate whether a dangerous condition exists or is developing.

### SUMMARY

An indicator device is disclosed. The indicator device has an enclosure containing a number of components. The indicator device includes a microcontroller having executable software adapted to receive data and calculate course, speed and coordinates of travel. A transceiver having antennae is also provided in communication with the microcontroller by a wired or wireless connection arranged to communicate data to the microcontroller. A proximity indicator is provided in communication with the microcontroller by a wired or wireless connection and arranged to communicate data to the microcontroller.

An alert system is also disclosed. The alert system includes a transmitting alert device having a wireless transceiver transmitting known transmitting device position information. A receiving alert device having a wireless transceiver is provided for receiving the transmitting device known position information from the transmitting alert device. The receiving alert device has a receiving device known position. A microcontroller in each alert device executes software utilizing a comparator function referring known receiving device position of the receiving alert device and received proximity information from the transmitting alert device, wherein known position of each alert device is coordinate based upon GPS signals received by each device or fixed coordinates, and wherein a dynamic proximity picture of real time position and rate of closure of the alert devices is obtained and communicated by a connected proximity indicator.

An active indicator method is also disclosed. The method includes the steps of a first active indicator obtaining its own GPS coordinate information, and analyzing the own GPS coordinate information by comparing recently obtained GPS information with previously obtained GPS information and other relative positional information to determine whether the first active indicator is moving, its direction of movement, velocity of movement, and change of velocity. The method also includes transmitting the own GPS information by RF signal with a wireless transceiver to other active indicators. The wireless transceiver is also used to receive GPS coordinate information from the other active indicators. Other active indicator GPS coordinate information is analyzed by comparing recently obtained GPS information with previously obtained GPS information and other relative positional information to determine whether the other active indicator is moving, its direction of movement, velocity of movement, change of velocity, and proximity to the first active indicator. Using this information, a determination is made whether to alert and alert intensity, and then an alert is delivered to the first active indicator indicative of the proximity and a rate of approach of the other active indicator.

Accordingly, a real-time proximity and rate of closure indicator is provided including an enclosure(s) to contain the required electronic componentry for transmission, reception and processing of RF signals for the determination, interpolation and comparison of positional information including rate of closure of all devices within a given signal reception range.

This information elevates this device into a new category of safety, by allowing operators and occupants of moving vehicles to be more aware of potential obstacles and or hazards—such as moving vehicles—with the additional benefit of a speed relative warning system. Data including range, course, speed, and bearing are collected, which is needed for a determination of intersection.

The speed relative warning system allows the conveyance of higher priority calls to action based on approach rate algorithms calculated by the device based on its own real time coordinates and received coordinate information from other compatible devices within transceiver range.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a cross-sectional view of one embodiment of an “alert device” constructed according to the present disclosure.

FIG. 2 provides several workflows for use of the device in various embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, wherein like reference numerals represent like parts throughout the several views, a portable indicator device and system for determining proximity and relative probability of intersection is provided, which may be particularly useful for increased safety in lower visibility conditions.

Generally, a real-time proximity and rate of closure indicator is provided. The indicator is defined by an enclosure containing the necessary electronic componentry for RF communication and relative positional information, and the required componentry for the interpolation of the relative position and rate of closure of each alert device and any other alert device within RF receiving range. The device includes a means to process the RF signals to provide and reference proximity information from the received RF signals, and apply processed information against known positional information.

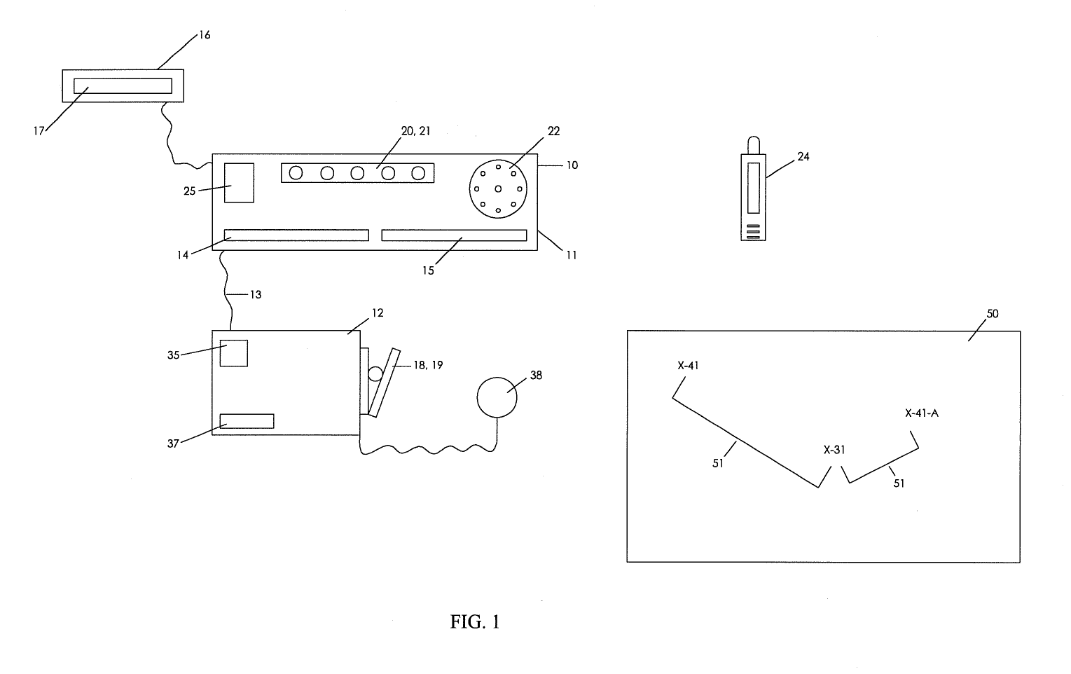

According to one or more examples of embodiments, the system is embodied in an alert device. The alert device is illustrated generally at 10 in FIG. 1. The alert device 10 includes an enclosure or housing 11 for a microcontroller and a transceiver that is formed of any suitable material, such as plastic, glass, ceramic, composite or metal, among others, and is generally small in size. Other operational components such as, but not limited to, a microcontroller or GPS unit may be housed in the same enclosure 11 or alternately in a separate enclosure 12 connected via wires 13 or other means of connecting the components in a communicable manner. The alert device 10 may have multiple differently sized shaped and configured enclosures 11, suitable for the intended purposes or installation. Provisions may also be made for attaching the enclosure(s) to a person and/or other objects, garments, helmets, vehicles, and the like. Enclosures may be constructed of a variety of materials which are the same or different than the main body of the device, such as but not limited to, silicone, metal, plastic, composites, ceramic or other polymers or thermoplastics.

As indicated, the indicator or alert device 10 may be constructed of a microcontroller 14, transceiver with suitable antennae 15, power supply 16, and proximity indicator(s) 20. One or more LEDs 21 and/or speakers 22 may also be provided controllable by the microcontroller 14, as well as an internal battery or power supply 25, or a power coupling for connecting to an external supply. Other components may also be added or included for the interconnectivity of the sub-components, which may assist in the proper functioning and communication of the alert device 10. For example, other components for interconnectivity may include, but are not limited to, wires, cables, PCB traces or other means of connecting the components, including short range wireless communication; each of which may be used to facilitate communication and cooperation of the associated componentry, allowing a rate of closure to be effectively calculated and communicated to the operator of a vehicle to which the equipment is attached, as well as any other compatible device within receiving range.

The device may also include other components in communication with the microcontroller, such as, but not limited to, tethering connection mechanism(s), accelerometers, gyroscopes, other movement-related sensor components, wireless internet or cellular data receivers, Bluetooth, data transfer mechanisms or devices such as USB, data storage mechanisms or devices such as a flash drive or RAM, a robust indicator system, such as an LCD or other screen, smart phone, or other components. A charging system may also be provided. For example, a solar charging device or an assembly to connect with a vehicle accessory port may also be included. In various embodiments, the power component may be a separate module from the device itself. The device may, in various embodiments, have low power consumption.

The accelerometers or other motion detectors may be used (if incorporated) first as a primary “wake up” signal generator to bring the microcontroller out of a power-conserving mode and into full inertial analytical mode, as well as increasing the rate of data transmission packets. In this regard, it is important for there to be sufficient real time proximity data transmitted relative to the transmitting device's acceleration and or velocity to enable receiving devices the ability to quickly and accurately plot, predict and/or anticipate the transmitting device's range, course, bearing and speed.

The above-described components will interact with one another via a wired or wireless connection to provide or communicate with the microcontroller the necessary information it needs—such as, but not limited to, acceleration, deceleration, GPS coordinates—to calculate the course and speed, as well as actual and anticipated GPS coordinates, for the course of travel.

As indicated, wireless internet and/or cellular transceivers are provided which will allow for communication between a variety of devices to enable reprogramming, software updates, and other non-hardware related updates and/or upgrades, as well as remote data acquisition. These transceivers interface with the microcontroller and any onboard memory devices, such as RAM or other solid state memory, for processing and/or storage of information, programs, instructions, or data relative to the vehicle or location on which the device is mounted.

In addition to the internal componentry described above, the alert device 10 is provided with one or more mechanisms for retaining and affixing 18, 19 the alert device 10 to objects and/or surfaces. Examples of such mechanisms include, but are not limited to, integrated magnet(s) in the housing(s) as well as tabs, slots, friction fit, tongue and groove, and the like, as may be used for using traditional fastening devices, and/or double sided adhesive tapes.

Referring to FIG. 1, in one or more examples of embodiments, the alert device utilizes a comparator function, referencing the known position 31 of the receiving alert device 10 and the received proximity information from the transmitting alert device 10. The known position of each device 10 is coordinate based upon GPS signals received by each device if it is onboard a vehicle, or using fixed coordinates when the device is stationary. By comparing the relative position of the transmitted coordinates of each device, as well as a data packet containing the past three (3) or more coordinate fixes, a moving device may also transmit the receiving device and projected range, course bearing, and speed which enables the determination of likelihood of a collision. This above-described threshold can be adjusted relative to either device's relative speed or other determining factors.

The known position and/or GPS coordinates are transmitted via a wireless transceiver from the microcontroller. The range of these transmissions is intentionally limited to be relatively short range so as not to encumber other vehicles or stationary devices with unnecessary calculations and transmissions for obstacles or vehicles which are not within the threshold of a speed relative zone of influence. In particular, the microcontroller of the receiving alert device 10 (which has a wireless transceiver that receives the transmitted signal from the transmitting alert device) compares its known position 31 against the positional information 41, 41A of the transmitting alert device(s) 10 to develop a dynamic proximity picture 50 of the real time position 41, 41A, 31 and rate of closure 51 of any and all alert devices within reception range 60. It is the rate of closure 51, or the rate of decrease in distance between the alert devices 30, 40, which may trigger the alert function in a cascading manner of increasing intensity based upon a preprogrammed rate of closure algorithm and actual time of intersection to determine each alert intensity threshold suitable for the particular application.

The rate of closure 51 and its corresponding alert intensity threshold will, in various embodiments, light high intensity LEDs 21 and high SPL speakers 22 to ensure notification of the corresponding alert intensity threshold regarding the rate of closure to the alert device 10 with most rapid rate of closure 51 of any alert device 10 within reception range. Reception range and transmission power output, and therefore range, can be varied based upon the microcontroller's anticipated likelihood of collision and the device's relative speed to another device within reception range. In general, it is not anticipated the receivable range is to be substantially more than the distance the moving vehicle can traverse in 30 seconds at maximum speed. This “restriction” helps to reduce “clutter” or otherwise irrelevant data, processing, as well as interference with other devices operating on similar frequencies.

In one or more examples of embodiments, the internal power supply 25 may allow for extended transmission of the emergency beacon in a “trouble situation”. The trouble situation can be triggered by a variety of means, including accelerometers 37, and ignition tethers 38, as examples. The trouble beacon may transmit information via radio signals on a similar frequency as traditional avalanche beacons so existing rescue equipment will be backwards compatible. The device may also have manual means to cancel the alert mode.

For example, if the vehicle the device 10 is attached to experiences a shock above a threshold gravitational force of 5 (this is just an example threshold) followed by little or no further movement, it can reasonably be assumed the vehicle has experienced a crash and/or collision. This situation, in conjunction with or separate from an ignition tether as is typically used on personal watercraft, can be used to trigger an emergency beacon mode. This mode transmits data relative to the emergency status of the vehicle and its GPS coordinates to all receiving devices within reception range. In one example, in the situation of an accident like this occurring on a marked trail with stationary devices mounted at intersections or other obstacles, the received emergency data can then be retransmitted from device-to-device whether they are mobile or not until all devices within a larger scale radius have received the emergency beacon and/or it is received by an emergency response team. The emergency response team will then have the exact coordinates of the occurrence and, optionally, may send an acknowledged signal along the same path of “daisy chained” devices to alleviate other equipped vehicles in the immediate area of the emergency alert.

The proximity indicators 20 can be mechanically and or wirelessly separated from the other components of the alert device 10, such as a Bluetooth connected heads up display 24 which can be mounted in the helmet, goggles or anywhere where visibility is improved. The device may also use Bluetooth or other connection means to display information via a smartphone application or screen. Note, while Bluetooth is specifically described, other wireless communication mechanisms, such as but not limited to near field communication systems, may also be acceptable.

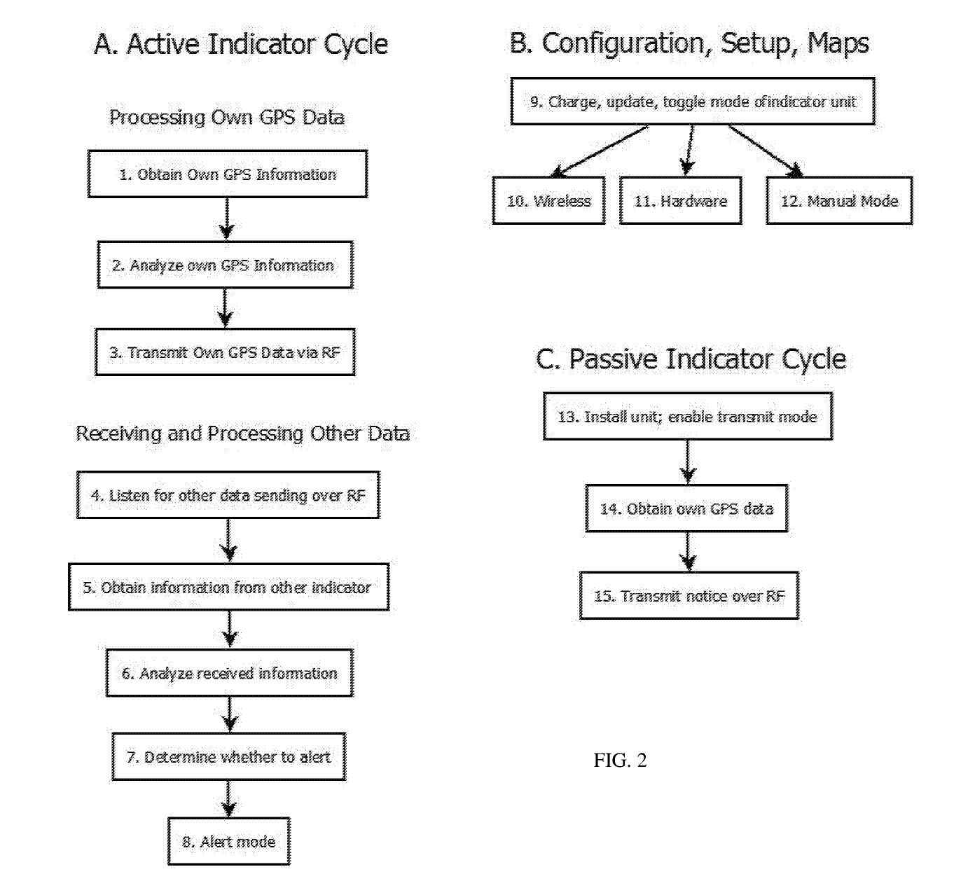

Referring to FIG. 2, several workflows of the system are disclosed. Beginning with section A: Active Indicator Cycle, an example cycle of an active indicator is disclosed. First, the active indicator or device obtains its own GPS coordinate information. In various embodiments, the device uses the GPS module to obtain this GPS coordinate information at regular intervals, for example, every second. In various embodiments, the device may modulate how frequently the information is obtained, for example, based on velocity. The system may use various algorithms to optimize this GPS data, suitable for the particular application. The device may also use other data points or technologies to fix the location of the device and its associated vehicle. For example, the device may use the absolute location of the device, but also the relative speed or relative position.

Step two of the Active Indicator Cycle indicates the GPS (or, in various embodiments, enhancing data points) information should be analyzed. In various embodiments, this may include comparing the recently obtained GPS information with previously obtained GPS information and/or other relative positional information in order to determine whether the alert device unit is moving, what direction the unit is moving, what velocity the unit is moving, whether the velocity is changing, among other data points. The rate of closure, acceleration, deceleration and or other proximity information needed for the calculation of rate of closure and/or other monitored motion or proximity relative attributes will be communicated to the microcontroller as signals conveyed via a wired or wireless means from the communication components onboard the device or remotely mounted upon the vehicle or other mounting location. The individual or combined motion and/or position monitoring components (e.g., GPS, accelerometers) signals are used upon receipt by the microcontroller to make the necessary calculations to determine the monitored variables, such as, but not limited to, GPS coordinates, speed, acceleration, and range to obstacles or other vehicles.

The described data is generated by the GPS receiver and the onboard accelerometers, and is interpreted by the microcontroller, calculating absolute position as well as course and speed from the GPS coordinate fixes and converting that data into useful information. The accelerometers provide for monitoring changes in speed, which can then be used to modulate or modify the frequency of transmitted data packets and transmitting power, and consequently range. If the transmitting device is travelling faster, it will have an increased rate of GPS fixes and an increased rate of transmitted data packets at a higher transmitted power output for extended range. In the opposite, when the vehicle to which the device is mounted slows to a much slower rate of travel or comes to a stop, the frequency and range of the transmitted proximity information may be less frequent.

The analyzed data described herein may be stored in an onboard memory unit such as RAM, an SD card, or solid state hard drive; the storage may be made by means of a database, file, or other storage structure. In various embodiments, this comparison may be made in conjunction with downloaded map data or real-time data mapping. To be more specific, the microcontroller may access maps showing known roads, and trails and use these for anticipating known obstacles relative to its current GPS position to alert the operator of the vehicle to known hazards even if they are not marked, or do not have stationary transmitting devices at those locations.

Step three of the Active Indicator Cycle indicates the GPS information is transmitted via RF. This transmission can be done in several ways; in one mode the transmission can be made as a general broadcast, not determining whether other alert device modules are in the area. In another mode, the transmission can be made to known and/or identified GPS or alert modules in the area. If this method is used, it should be understood that the module's awareness of other units may be made during the receiving/listening mode as outlined further herein; awareness could also be made during a group pairing cycle or other programming means for a stationary programming unit. Various kinds of information may be transmitted via RF, for example: the module may transmit pure GPS coordinates, it may transmit a vehicle identifier, it may transmit a unique device identifier, it may transmit processed velocity/acceleration/directional data about the unit, it may transmit a help beacon, and/or it may transmit any other known useful data to receiving devices. The transmission of the data should be understood as being substantially immediate with the acceptance of the GPS (or enhancing) data. The data communications are wirelessly communicated between devices within range of each other via a wireless transceiver controlled by the microcontroller. The information transmitted and received is proximity and absolute GPS coordinates, as well as several previously fixed GPS coordinates of the transmitting device. This is especially useful in plotting the trajectory of the transmitting device to assist in anticipation of the location of the transmitting device over time.

Step four begins the description of the receiving and processing of other data cycle. It should be understood that the alert device allows for both listening and transmitting. All mobile devices, in order to function correctly, should have a means of two-way communication with other mobile devices. Through the use of wireless transceivers, the devices may communicate with one another. It is anticipated this will be via a wireless transmission in the 900 MHz range, but could be any frequency capable of traversing the required distance to be useful in conveying data. In various embodiments, the device performs the operations of obtaining GPS data, transmission, receipt and alert determination in a substantially simultaneous manner. Therefore, in step the device actively listens for data submission by other units. This information may contain data from other units beyond reception range. The device may be configured to filter the data it listens for according to certain parameters, including transmission band, serial numbers, proximity information, or attenuation. As a result, the device may filter otherwise relatively unimportant information.

Step five specifies the system obtains the information from the other indicator device. This may involve storing the transmitted data in a temporary storage location (i.e. RAM). In the case of simultaneous transmissions by several units, the sequenced and time stamped temporary storage of each device(s) transmission into RAM or another type of solid state memory may need to be correlated with its device identifier. This ability allows the onboard microcontroller to cope with near simultaneous reception of data packets from multiple devices. The transmitted information carries the transmitting device's unique identifier number allowing the receiving device the means of identifying it amongst all other received transmissions, as well as correlating subsequent transmissions to better develop a more accurate anticipated course and speed of the vehicle which transmitted its information. The device may be programmed to understand the type, length, and content of the transmitted data packet. In various embodiments, the sending transmission will use a device indicator code to ensure identification of the device and its information as an indicator of the type disclosed herein.

Step six specifies the alert device system analyzes the received information. Analysis may have various steps and/or requirements depending on the type of data transmitted to the device. If the sending device has already determined velocity and direction and sent the data in the transmission, the receiving unit may need to merely pull the relevant data from the transmission and compare with its own determined location, direction, and velocity. If pure GPS data is transmitted, the device may need to acquire additional GPS data from the same unit in order to determine velocity and direction as necessary to perform a comparator function. The unit may send, for example, the five (5) last obtained GPS coordinate fixes to provide a clear picture of the transmitting device's range, course, speed, and bearing. If multiple GPS data points are used, the receiving device may determine direction, velocity, and acceleration. Additional parameters may be understood by the device including what type of obstruction is anticipated by the device. These determinations may be stored in any suitable memory storage location provided in the device using any suitable memory storage means, such as, but not limited to, relational or other type of database, text file, or other software-based data structure, random-access memory, direct-access memory, or SD cards.

Step seven specifies the system determines whether to alert and what alert intensity to make. The decision to alert can be based on several parameters. On an initial level, the determination can be made on distance or calculated time of anticipated intersection between the sending and receiving device, providing for minimized false alarms for alerts based on the range. The determination may also be made based on sending device details such as velocity, associated object type, and trajectory. The alert may also adjust according to environmental factors, such as visibility, map input, or other factors if the device is provided with adequate information to make that determination (through additional sensors or other means). As such, the receiving device user may be alerted to trees, bridges, sharp corners, or other obstructions. The device may be programmed with individualized threshold values to determine the alert type, minimizing false alerts and providing meaningful feedback to users based on the obtained information. The individual user's device may be customized for individual user preferences regarding the alerts, such as the alert intensity or frequency. As part of the individualized threshold values, the system may decide whether or not to alert or what level or type of alert to provide. For example, the system may have a different type of alert for different types of potential hazards provided by the sending device.

In one or more examples of embodiments, the device may be activated to enter into a “group mode” which may toggle the device functionality relative to a group of devices provided within a certain area. When operating in “group mode,” which can be activated by the use of an application on a mobile device or via a switch on the vehicle directly wired into the transmitting device, or on the device itself. A number of devices can be synced with one another to modify the operating parameters. If “group mode” is activated, an alert may notify the associated group of alert devices if one of the devices slows down or stops moving. “Group mode” may also set the device to change the alert threshold for the devices in the group or otherwise alter the threshold based on the group mode devices nearby. In various embodiments, the group mode may be activated by multiple GPS hits in same location. In other embodiments, group mode can be activated through manual means. Relative position and relative identification information can be triggered by toggling the group mode.

As indicated above, the device may also be activated to enter into an “emergency mode.” Several GPS hits in a single location, changes detected by an accelerometer or other sensor, or activation of tethering means may cause the device to enter into emergency alert mode. The emergency alert mode may cause the device to repeatedly transmit the specific GPS coordinates to all devices within reception range as well as give instructions to the receiving devices to retransmit the same information extending the range of the emergency beacon. In various embodiments, the device may couple via Bluetooth or other means to a cell phone, which may use cell phone functionality to enhance alert functionality; for instance by calling or texting an emergency contact.

Step eight specifies the system enters “alert mode.” In various embodiments, the device will activate lights which will illuminate in intensity, number, or frequency relative to the determined level or type of alert. In various embodiments, the device will activate a speaker which may emit sound at a particular pitch, melody, or amplitude relative to the determined level or type of alert. As detailed above, the indicator and/or its components may be mounted in various places in order to best provide for visibility of the alert while maintaining safety. The system may provide for other types of alerts, such as means to communicate the direction of approach. The system may provide for other means of alert, such as an LCD screen, other types of display, and/or using a smartphone screen connected via Bluetooth.

For example, means of alert may be provided by way of a smart phone application connected to the device by Bluetooth. While the application may be suitable for providing the alert, the application may be leveraged for other uses. For example, the application could include mapping, advertisements for nearby establishments, or other software-enabled functionality. The software application may also provide for logging various information usages and provide data to third parties; for example, by providing information about trail usage by snow mobile riders to relevant DNR authorities.

Referring to section B, “Configuration, Setup, Maps” of FIG. 2, functionality of the device when it is not in “indicator mode” is disclosed. Step nine specifies that the device may charge, update, or toggle the mode of the indicator unit or device. In various embodiments, updating may include transfer of information such as maps, location history, record of interaction with other devices (both mobile and stationary), software changes, or other information between the various devices described herein.

Step ten specifies functionality may be performed wirelessly. In various embodiments, this involves using wireless internet and/or Bluetooth to update or change the mode or programming of the device. This may be performed by using a built-in wireless connection device.

Step eleven specifies functionality may be done using hardware. The device may be connected to a computer or smartphone via a USB cable or other means. While connected, data may be removed from or transferred to or from the device. The device may also charge off of the connection.

Step twelve specifies manual updates, charging, or toggling of alert device unit mode. In various embodiments hardware modifications may be made, allowing the user to change out certain components such as certain modules—both hardware and software such as updating maps, or swapping out components such as the transmitters or removable memory cards. This allows for cost-effective updates to the device to keep pace with new technologies without necessitating a new purchase of the entire device. In addition, the user may be able to manually plug the unit in or wire it to a vehicle for charging. Finally, the device may be able to be switched to certain modes through a button provided on the device. These modes may include, but are not limited to, “group mode,” “passive mode,” “indicator mode,” “emergency beacon cancellation mode,” or turning the device off.

Referring to section C, “Passive Indicator Cycle,” of FIG. 2, the device may be attached to a non-moving object instead of a moving object. For example, the alert device unit may be installed in a suitable location to notify a mobile device of a hazard, such as a pole on a steep curve, buoy in a rocky area, a tree, or the like. The unit may also be installed in a location suitable to track or monitor traffic. In order to facilitate this use, the device may have a passive indicator cycle.

Step thirteen specifies the unit should be installed and “transmit mode” enabled. The unit may be installed in any way suitable to its intended purpose—for example using straps, sticking mechanisms, or any other known fastening mechanisms or devices. The unit may be set to a transmit mode; this may be enabled using manual means or other means, for example those outlined above.

Step fourteen specifies the unit will obtain its own GPS coordinates. Step fifteen specifies the unit will transmit notices over RF. This notice may specify that the object is a stationary obstacle or other data to listening units. Though not included as a step, the device may also record broadcasts by other devices that pass by and various data about or conveyed from those devices such as their change in or relative velocity.

The disclosed device and system herein provide various advantages over existing devices and addresses shortfalls of existing technology with its ability to convey actual real time proximity, as well as its means for the computation of an approach rate (velocity and acceleration), angle, and distance relative to all other compatible devices within the range of the device's transceiver.

A real-time proximity and rate of closure indicator is provided including an enclosure(s) to contain the required electronic componentry for transmission, reception and processing of RF signals for the determination, interpolation and comparison of positional information including rate of closure of all devices within a given signal reception range. This information elevates this device into a new category of safety by allowing operators and occupants of moving vehicles to be more aware of potential obstacles and or hazards such as moving vehicles with the additional benefit of a speed relative warning system. The speed relative warning system allows the conveyance of higher priority calls to action based on approach rate algorithms calculated by the device based on its own real time coordinates and received coordinate information from other compatible devices within transceiver range.

It should be noted that the detailed disclosure above provides a specific example of particular embodiments of the system. Various changes can be made which would not depart from the overall scope of the invention.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied. The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions.

Moreover, some portions of the detailed descriptions herein are presented in terms of procedures, steps, logic blocks, processing, and other symbolic representations of operations on data bits that can be performed on computer memory. These descriptions and representations are the means used by those skilled in the data-processing arts to most effectively convey the substance of their work to others skilled in the art. A procedure, computer-executed step, logic block, process, etc. is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind; however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms, such as “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within the computer system.

In one or more examples of embodiments the system and/or method may be implemented by a computer system or in combination with a computer system. The computer system may be or include a processor. The computers may be portable electronic devices for use with the methods and various components described herein and may be programmable computers which may be special purpose computers or general purpose computers that execute the system according to the relevant instructions. The computer system or portable electronic device can be an embedded system, a personal computer, notebook computer, server computer, mainframe, networked computer, workstation, handheld computer, as well as now known or future developed mobile devices, such as for example, a personal digital assistant, cell phone, smartphone, tablet computer, and the like. Other computer system configurations are also contemplated for use with the communication system including, but not limited to, multiprocessor systems, microprocessor-based or programmable electronics, network personal computers, minicomputers, smart watches, and the like. Preferably, the computing system chosen includes a processor suitable in size to efficiently operate one or more of the various systems or functions or attributes of the communication system described.

The system or portions thereof may also be linked to a distributed computing environment, where tasks are performed by remote processing devices that are linked through a communication network(s). To this end, the system may be configured or linked to multiple computers in a network including, but not limited to, a local area network, wide area network, wireless network, and the Internet. Therefore, information, content, and data may be transferred within the network or system by wireless means, by hardwire connection, or combinations thereof. Accordingly, the servers described herein communicate according to now known or future developed pathways including, but not limited to, wired, wireless, and fiber-optic channels.

Data may be sent or submitted via the Internet, wireless, and fiber-optic communication network(s), or created or stored on a particular device. In one or more examples of embodiments, data may be stored remotely or may be stored locally on the user's device. In one example, data may be stored locally in files. Data may be stored and transmitted by and within the system in any suitable form. Any source code or other language suitable for accomplishing the desired functions described herein may be acceptable for use.

Furthermore, the computer or computers or portable electronic devices may be operatively or functionally connected to one or more mass storage devices, such as but not limited to, a database. The memory storage can be volatile or non-volatile, and can include removable storage media. Cloud-based storage may also be acceptable. The system may also include computer-readable media which may include any computer-readable media or medium that may be used to carry or store desired program code that may be accessed by a computer. The invention can also be embodied as computer-readable code on a computer-readable medium. To this end, the computer-readable medium may be any data storage device that can store data which can be thereafter read by a computer system. Examples of computer-readable medium include read-only memory, random-access memory, CD-ROM, CD-R, CD-RW, magnetic tapes, flash drives, as well as other optical data storage devices. The computer-readable medium can also be distributed over a network-coupled computer system so that the computer-readable code is stored and executed in a distributed fashion.

While this invention has been described in conjunction with the examples of embodiments outlined above, various alternatives, modifications, variations, improvements, and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements, and/or substantial equivalents.

The technical effects and technical problems in the specification are exemplary and are not limiting. It should be noted that the embodiments described in the specification may have other technical effects and can solve other technical problems.

1. An indicator device comprising:
an enclosure containing:
a microcontroller having executable software adapted to receive data and calculate course, speed and coordinates of travel;
a transceiver having an antennae, and in communication with the microcontroller by a wired or wireless connection arranged to communicate data to the microcontroller; and
a proximity indicator in communication with the microcontroller by a wired or wireless connection arranged to communicate data to the microcontroller.

2. The indicator device of claim 1, further comprising one or more LEDs controllable by the microcontroller.

3. The indicator device of claim 1, further comprising one or more speakers controllable by the microcontroller.

4. The indicator device of claim 1, further comprising a power supply connected to the alert device.

5. The indicator device of claim 1, further comprising a tethering connection mechanism in communication with the microcontroller.

6. The indicator device of claim 1, further comprising a movement sensing device in communication with the microcontroller, the movement sensing device selected from the group consisting of an accelerometer and a gyroscope.

7. The indicator device of claim 1, further comprising at least one of a wireless internet transceiver or a cellular transceiver.

8. An alert system comprising:
a transmitting alert device having a wireless transceiver transmitting known transmitting device position information;
a receiving alert device having a wireless transceiver receiving the transmitting device known position information from the transmitting alert device, wherein the receiving alert device has a receiving device known position;
a microcontroller in each alert device executing software utilizing a comparator function referring known receiving device position of the receiving alert device and received proximity information from the transmitting alert device, wherein known position of each alert device is coordinate based upon GPS signals received by each device or fixed coordinates, and wherein a dynamic proximity picture of real time position and rate of closure of the alert devices is obtained and communicated by a connected proximity indicator.

9. The alert system of claim 8, wherein the proximity indicator comprises LEDs and speakers controlled by the microcontroller, such that the rate of closure delivers a corresponding alert.

10. The alert system of claim 8, wherein the microcontroller is in communication with an emergency beacon.

11. The alert system of claim 8, wherein the proximity indicator is mechanically or wirelessly separated from the alert device.

12. The alert system of claim 11, wherein the proximity indicator is connected to the alert device by Bluetooth.

13. The alert system of claim 8, wherein the system comprises an alert mode.

14. The alert system of claim 8, wherein the system comprises a group mode.

15. The alert system of claim 8, wherein the system comprises an indicator mode.

16. The alert system of claim 8, wherein the system comprises a transmit mode.

17. The alert system of claim 8, wherein the transmitting alert device is attached to a non-moving object.

18. An active indicator method comprising:
a first active indicator obtaining its own GPS coordinate information;
analyzing the own GPS coordinate information by comparing recently obtained GPS information with previously obtained GPS information and other relative positional information to determine whether the first active indicator is moving, its direction of movement, velocity of movement, and change of velocity;
transmitting the own GPS information by RF signal with a wireless transceiver to other active indicators;
using the wireless transceiver to receive GPS coordinate information from the other active indicators;
analyzing other active indicator GPS coordinate information by comparing recently obtained GPS information with previously obtained GPS information and other relative positional information to determine whether the other active indicator is moving, its direction of movement, velocity of movement, change of velocity, and proximity to the first active indicator;
determining whether to alert and alert intensity; and
delivering an alert to the first active indicator indicative of the proximity and a rate of approach of the other active indicator.
